(19) United States
(12) Patent Application Publication
(10) Pub. No.: US 2002/0113398 A1
(43) Pub. Date: Aug. 22, 2002

(54) Damper mounting

(76) Inventor: Ralf Berner, Krefeld (DE)

Correspondence Address: Todd T. Taylor, TAYLOR & AUST, P.C., 142 S. Main St., P.O. Box 560, Avilla, IN, 46710, US

(21) Appl. No.: 10/047,658

(22) Filed: Jan. 15, 2002

(30) Foreign Application Priority Data
Jan. 16, 2001 (DE) 201 00 723.1

(51) Int. Cl. B60G 15/00

(52) U.S. Cl. 280/124.155

(57) ABSTRACT

A damper mounting, particularly for use in a motor vehicle, for receiving a first end of a damper which in the axial direction damps the movements of a member, such as a wheel carrier, fixed to the other or second end of the damper. The damper mounting includes a mounting housing which can be fixed to a structure, such as the bodywork of a motor vehicle, a mounting core which is arranged in the mounting housing and to which the first end of the damper can be fixed, and one or more individual elastomer elements which are arranged between the mounting core and the inside wall of the mounting housing and co-operatively hold the mounting core in position relative to the mounting housing.

### BACKGROUND OF THE INVENTION

1. Field of the Invention

The present invention relates to a damper mounting, particularly—though not exclusively—for use in a motor vehicle, for receiving a first end of a damper which in the axial direction damps the movements of a member, such as a wheel carrier, fixed to the other end of the damper, wherein the damper mounting includes a mounting housing which can be fixed to a structure, such as the bodywork of a motor vehicle, a mounting core which is arranged in the mounting housing and to which the first end of the damper can be fixed and at least one elastomer element which is arranged between the mounting core and the mounting housing.

2. Description of the Related Art

Damper mountings of the above-described kind exist in a large number of different forms. In that respect different functions can be attributed to the damper mounting. One function of the damper mounting is to be of such a design configuration that the mounting core connected to one end of the damper, in the mounting housing, involves movements defined within predetermined limits. By virtue of the selection of a suitable elastomer element which is disposed between the mounting core and the mounting housing fixedly secured to a structure, such as the bodywork of a motor vehicle, the range of movement of the mounting core can be determined by virtue of the elasticity of the material involved. Another function of the damper mounting is that of preventing sound conducted through solid material from being transmitted from the damper to the structure. A further function of the damper mounting is to damp the oscillations of the damper so that such oscillations are not transmitted to the structure.

Particular significance is attributed to the choice of the elastomer material with respect to implementation of the various functions. The choice of the elastomer material relates both to the choice of a suitable material and also the configuration adopted. The configuration includes dimensioning (height, thickness, width) and additional specifications, for example, biasing of the elastomer element.

The optimum attainment of a single function can result in an elastomer element whose material properties and configuration are not the optimum with respect to attaining the other functions. Therefore the choice of a suitable elastomer material and the design configuration are complex matters as all functions are to be achieved in as optimum a fashion as possible.

The complexity in terms of designing the damper mounting is increased by virtue of the fact that different demands are made on the elastomer element in the axial and radial directions of the mounting.

Known damper mountings of the above-described kind include components which are connected together in firmly adhering relationship by an elastomer material or have elastomer material injection molded therearound. What is sought is an elastomer material which satisfies the most widely varying demands in the different directions, as well as possible. The characteristics in various directions in space are different, by virtue of specifically targeted configuring of the elastomer element. By virtue of the different functions to be performed, the design configuration of the elastomer element and a suitable choice of the elastomer material imply that it is only possible to arrive at a compromise in which the individual functions, considered in themselves, are only attained in a sub-optimum fashion.

What is needed in the art is a damper mounting which is of a simple structure and with which the different demands on the mounting can in total be better satisfied.

### SUMMARY OF THE INVENTION

The present invention includes one or more individual elastomer elements which are arranged between the mounting core and the inside wall of the mounting housing and which co-operatively hold the mounting core in position relative to the mounting housing.

The present invention uses a plurality of elastomer elements to employ widely differing materials with correspondingly different material properties. By choosing different materials for the individual elastomer elements, it is possible to optimally satisfy individual demands which are made on the damper mounting. However, not just the material but also the configuration of the individual elastomer elements may be different. The behavior of each individual elastomer element in the mounting can be adapted, by virtue of the different configuration of the individual elements, just as in regard to the choice of materials. By varying the combination of the individual elements with their respectively different properties, it is possible to design a damper mounting such that the individual demands can in total be better satisfied. The present invention equally makes it possible to produce damper mountings of predetermined quality less expensively as expensive elastomer elements which satisfy all demands are replaced by a plurality of elements, to each of which are attributed only partial functions.

Advantageously, an elastomer element can be so designed that it holds the mounting core in position acting only in the axial direction. The shape and material of the elastomer element can be selected according to the demands involved in the axial direction, without taking account of demands of radial support.

In the same manner, at least one elastomer element can compensate for the movements of the mounting core only in a radial direction. In regard to the choice of the elastomer element only the demands which are relevant for the mounting in the radial direction have to be taken into consideration.

An elastomer element can be biased or prestressed in the damper mounting. The behavioral characteristics of the elastomer element can be influenced by the biasing effect.

Advantageously, the individual elastomer elements can be arranged, without connecting the individual elastomer elements to each other, between the mounting core and the mounting housing. For example, in the procedure for assembly of the damper mounting, the individual elastomer elements are only laid in the housing, without being glued or otherwise joined to each other or to the mounting core and the housing. That is advantageous in the development of the mountings when the interaction of the individual elastomer elements and the overall characteristics of the damper mounting is tested, as individual elements can be readily fitted and removed.

In a preferred embodiment at least one elastomer element in the damper mounting may be of polyurethane.

Advantageously the mounting core has a side which is remote from the damper and a side which is towards the damper. A plurality of elastomer elements can be arranged bearing against each other in the axial direction of the damper at at least one side of the mounting core. For example the elastomer elements may be of different materials with different material properties so that in the axial direction it is possible to set a desired dependency between deflection of the mounting core with respect to the mounting housing and the force which acts on the mounting core due to the damper. As in the case of a series arrangement of springs, the deflections of the individual elastomer elements are added in the axial direction to constitute an overall deflection corresponding to the deflection of the mounting core. In that situation the individual elastomer elements each experience the same respective force in the axial direction.

In addition, a plurality of elastomer elements can be arranged in mutually juxtaposed relationship between the mounting core and the housing at at least one side of the mounting core in a plane which extends perpendicularly to the axial direction of the damper. Upon deflection of the mounting core in the axial direction the height of the individual elastomer elements changes by the amount of the deflection. The forces which are produced in the individual elastomer elements are added as in the case of a spring arrangement which is connected in parallel, so that in this arrangement, it is also possible to set a tailor-made dependency between the deflection of the mounting core and the behavioural characteristics of the damper mounting. In principle it is also possible to provide a combination of elastomer elements which are disposed in mutually superposed relationship and elements which are disposed in mutually juxtaposed relationship.

Advantageously, a plurality of elastomer elements can also be arranged coaxially in a radial direction. In this arrangement, the elastomer elements lie one above the other in the radial direction so that the desired properties can be set by the choice of suitable elastomer materials and thickness of the elastomer elements in the radial direction.

In a preferred embodiment the elastomer elements which bear against one side of the mounting core involve different bias effects in the axial direction. The behaviour of the elastomer element can also be predetermined by a biasing effect in an elastomer element. A different biasing effect can be achieved for example by the elastomer elements being compressed to different degrees in the axial direction between the mounting core and the inside wall of the mounting housing upon assembly of the mounting.

The mounting core can be in the form of a rotationally symmetrical disc having a coaxial bore through which the said first end of the damper can be passed. If a screwthread is provided at the end of the damper the damper can be easily fixed to the mounting core by way of a screw.

In a preferred embodiment, annular elastomer elements bear in the axial direction against a respective side of the circular disc of the mounting core, the mounting core having a configuration for centering the annular elastomer element. The centering effect can be produced for example by a collar arranged concentrically with respect to the circular disc. The outside diameter of that collar corresponds to the inside diameter of the annular elastomer element causing the elastomer element to be centered with respect to the mounting core.

As an alternative thereto or in addition an annular elastomer element may have centering component at the outer periphery. An example in that respect are projecting portions which project in the radial direction at the outer periphery of the annular element and which are arranged at equal spacings from each other in the peripheral direction. Those projecting portions bear against the inside wall of the housing in the radial direction and thereby center the annular elastomer element. The projecting portions can include the same material as the ring itself.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a view in cross-section of a first embodiment, and

FIG. 2 is a view in cross-section of a second embodiment.

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF THE INVENTION

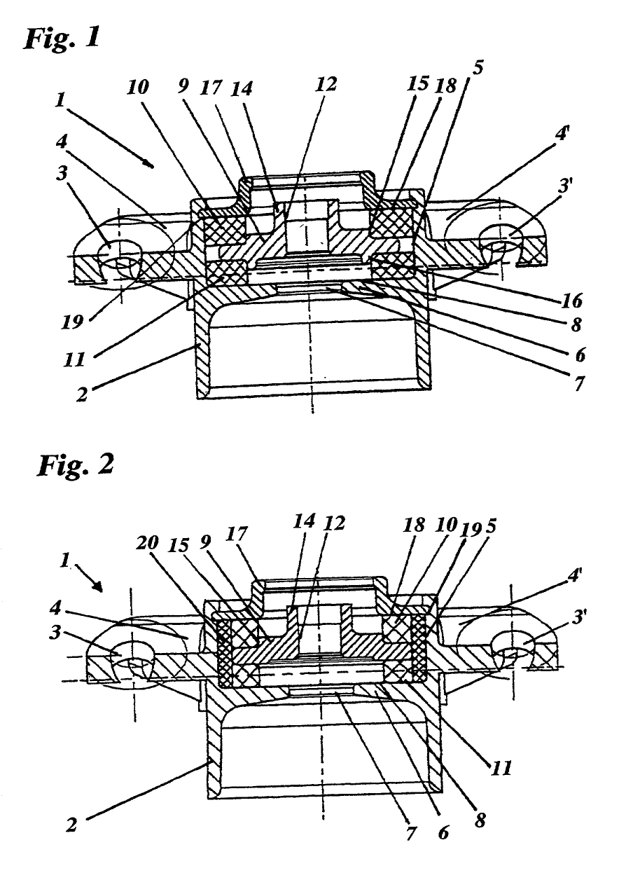

Referring now to the drawings, and more particularly to FIG. 1, there is shown a damper mounting 1 which generally includes mounting housing 2 having two bores 3 and 3′. Damper mounting 1 can be connected to the bodywork of a vehicle for example by screws which are passed through the bores. Bores 3 and 3′ are each provided in flanges 4 and 4′ which, forming a unit with cylindrical receiving element 5, represents mounting housing 2. Cylindrical receiving element 5 has a bottom 6 in which there is a hole 7 concentrically with respect to the axis of cylindrical receiving element 5. Bottom 6 has a bottom surface 8 which extends perpendicularly to the axis of the cylinder. Arranged in the cavity of cylindrical receiving element 5, which is formed by the peripheral surface of cylindrical receiving element 5 and bottom 6, are a mounting core 9 and two annular elastomer elements 10 and 11. Elastomer element 10 and elastomer element 11 are in the form of a ring whose outside diameter corresponds to the inside diameter of cylindrical receiving element 5. Elastomer element 11 bears with one side flat against surface 8 of bottom 6. In this arrangement the inside diameter of the annular elastomer element 11 is larger than the diameter of hole 7 in bottom 6. Mounting core 9, with the side thereof which is towards the damper, bears against the side of elastomer element 11, which is remote from surface 8 of bottom 6. Mounting core 9 is a rotationally symmetrical body whose axis of rotation coincides with the axis of cylindrical receiving element 5. Mounting core 9 has a bore 12 through which the one end of the damper can be pushed. The damper can be fixed to mounting core 9 by suitable fixing methods. For example, the end of the damper is in the form of a rod with a screwthread, which is pushed through bore 12 in mounting core 9. A nut (not shown) can be screwed onto the screwthread so that the nut can bear against the shank portion 14 of mounting core 9. The rod of the damper (not shown), at a predetermined spacing relative to the screwthread on the rod, has a peripherally extending spring in the form of a ring so that the spring bears against the side of mounting core 9 which is towards the damper and the damper is fixedly connected to mounting core 9 in the axial direction.

For the purposes of centering mounting core 9 within cylindrical receiving element 5, mounting core 9 has a collar 15 whose outside diameter corresponds to the inside diameter of annular elastomer element 10. In addition, an annular step 16 which is concentric with respect to the axis of cylindrical receiving element 5 is provided for centering purposes on the side of mounting core 9 which is towards the damper. Elastomer element 10 bears against mounting core 9, on the side of mounting core 9 which is remote from the damper. A mounting cover 17 is disposed at the end of cylindrical receiving element 5, which is remote from the damper. Mounting cover 17 has, on the side towards the damper, a flat annular surface 18 which bears against a side of the annular elastomer element 10.

Mounting cover 17 is fixedly connected to damper mounting I at cylindrical receiving element 5. In the assembled condition as shown in FIG. 1 mounting cover 17 is arranged in such a way that elastomer elements 10 and 11 are biased in the axial direction of the damper. Depending on the respective position of mounting cover 17 relative to cylindrical receiving element 5 or depending on the respective height of the individual elastomer elements 10 and 11 it is possible to achieve a predetermined biasing effect.

To assemble damper mounting 1, elastomer element 11 is first fitted into cylindrical receiving element 5, laid on surface 8 of bottom 6. Mounting core 9 and the second elastomer element 10 are then installed. Mounting core 9 is arranged concentrically with respect to cylindrical receiving element 5 by virtue of step 16 and collar 15.

In the end region of cylindrical receiving element 5, which is remote from the damper, the thickness of the wall of the cylinder is somewhat thinner so that an annular receiving element 19 for mounting cover 17 is formed in the cavity in the cylinder at the wall of the cylinder. Mounting cover 17 is laid with its annular surface 18 on the annular receiving element 19. Thereafter the upper region of the end of cylindrical receiving element 5 is rolled radially inward so that mounting cover 17 is fixedly connected to mounting housing 2.

Elastomer elements 10 and 11 can primarily damp or restrain in the axial direction movements of the damper which is fixedly connected to mounting core 9. Due to step 16 and collar 15, radially acting forces are also transmitted from mounting core 9 to elastomer elements 10 and 11.

FIG. 2 shows a second embodiment which differs from the first embodiment in regard to the arrangement and number of the elastomer elements and the structure of mounting core 9. In this embodiment the damper mounting includes three elastomer elements 10, 11 and 20. In contrast to FIG. 1 mounting core 9 in the second embodiment does not have any centering component at the side of mounting core 9, which is towards the damper. In the embodiment in FIG. 2, centering of mounting core 9 is effected on the one hand by way of collar 15 and by way of the disc with a diameter of mounting core 9, which corresponds to the diameter of elastomer element 20 which is also annular. By virtue of that arrangement the forces acting radially on mounting core 9 are transmitted directly and indirectly by way of shank portion 14 of mounting core 9, by way of elastomer element 10, to elastomer element 20 which is also annular. Elastomer element 20 does not receive any axial forces whatsoever, from mounting core 9. Therefore, the choice of the material for elastomer element 20 can disregard the loadings in the axial direction of the damper mounting. Elastomer element 1 1 only receives axially acting forces so that radially acting influences can remain disregarded, in terms of the choice of that elastomer element.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A damper mounting for receiving a first end of a damper which damps movement in an axial direction, said damper mounting comprising:
a mounting housing including an inside wall;
a mounting core which is arranged in said mounting housing and to which the first end of the damper can be fixed; and
at least one elastomer element, each said elastomer element being arranged between said mounting core and said inside wall and cooperatively holding said mounting core in position relative to said mounting housing.

2. The damper mounting of claim 1, wherein at least one said elastomer element holds said mounting core in position operatively only in a radial direction.

3. The damper mounting of claim 1, wherein at least one said elastomer element holds said mounting core in position operatively only in the axial direction.

4. The damper mounting of claim 1, wherein at least one said elastomer element is compressed between said mounting core and said mounting housing in the axial direction.

5. The damper mounting of claim 1, wherein at least one said elastomer element is arranged free of connection between said mounting core and said mounting housing.

6. The damper mounting of claim 1, wherein at least one said elastomer element is comprised of polyurethane.

7. The damper mounting of claim 1, wherein said mounting core is positionable with a side of said mounting core remote from said damper and a side of said mounting core towards said damper and that arranged between said mounting core and said mounting housing at at least one side of said mounting core are a plurality of said elastomer elements which lie one upon the other in the axial direction of the damper.

8. The damper mounting of claim 7, wherein a plurality of said elastomer elements are arranged in mutually juxtaposed relationship between said mounting core and said mounting housing at at least one side of said mounting core in a plane which extends perpendicularly to the axial direction of the damper.

9. The damper mounting of claim 7, wherein said elastomer elements bears against one of said side remote from said damper and said side towards said damper, of said mounting core involve different biasing effects in the axial direction.

10. The damper mounting of claim 1, wherein a plurality of said elastomer elements are arranged in mutually coaxial relationship in a radial direction.

11. The damper mounting of claim 1, wherein said mounting core is in the form of a rotationally symmetrical disc with a coaxial bore through which said first end of said damper can be passed.

12. The damper mounting of claim 11, wherein at least one said elastomer element is an annular elastomer element, in the axial direction said annular elastomer element bearing against a respective side of said rotationally symmetrical disc of said mounting core, wherein said mounting core has a centering element for said annular elastomer element.

13. The damper mounting of claim 12, wherein said centering element is positioned at the outer periphery of said annular elastomer element.

14. A motor vehicle, comprising:
a bodywork;
a wheel carrier;
a damper having a first end and a second end, said second end fixed to said wheel carrier, said damper damping, in an axial direction of said damper, movement of said wheel carrier fixed to said second end;
a damper mounting for receiving said first end, said damper mounting comprising:
a mounting housing including an inside wall, said mounting housing fixed to said bodywork;
a mounting core arranged in said mounting housing, said mounting core being fixed to said first end; and
at least one elastomer element, each said elastomer element being arranged between said mounting core and said inside wall and cooperatively holding said mounting core in position relative to said mounting housing.
